(19) United States
(12) Patent Application Publication
(10) Pub. No.: US 2025/0352928 A1
(43) Pub. Date: Nov. 20, 2025

(54) Water Filter System and Method

(71) Applicant: Keith Bernard, Miramar, FL (US)

(72) Inventor: Keith Bernard, Miramar, FL (US)

(21) Appl. No.: 18/667,016

(22) Filed: May 17, 2024

(51) Int. Cl. B01D 29/58; B01D 29/15

(52) U.S. Cl. CPC B01D 29/58; B01D 29/15; B01D 2201/188; B01D 2201/287; B01D 2201/291; B01D 2201/302; B01D 2201/306; B01D 2201/307; B01D 2201/4038; B01D 2201/4046; B01D 2201/4092

(57) ABSTRACT

A system and method is provided for filtering water using a pre-filter and a primary filter, both removably disposed within a housing. The pre-filter is placed in series with the primary filter. The pre-filter includes a cavity within which the primary filter may be at least in part disposed. In one embodiment, the pre-filter and the primary filter are each removably received within the housing, so that either or both of the pre-filter and primary filter may be easily removed from the housing and replacement filters provided. Thus, a simple, convenient, compact filtering apparatus is provided.

### FIELD OF THE DISCLOSURE

The invention relates generally to system and method for water filtration, and more specifically, to a pre-filter for use in connection with a primary water filter received within a cavity formed by the pre-filter, so as to create a compact pre-filter/filter combination, and a housing within which the pre-filter and primary water filter are each removably received for ease of replacement.

### BACKGROUND

A number of systems exist to filter water. For non-industrial applications where a source of water is a hose and spigot, consumers typically use an inline water filter that is adapted for connection between the spigot or hose, or between two hoses. Such filters may be used, by way of example only, for water provided to campers or to a recreational vehicle while parked at a campsite.

Numerous problems exist with the use of such inline filters. For example, inline filters typically are disposable and need to be changed frequently. They have a limited life span in that once they filter out a certain level of particulates, the inline filter must be changed and disposed of. Inline filters also typically cannot be cleaned for reuse.

Thus, there remains a need for an improved, simple, and cost-effective system and method to filter water for consumer use.

### SUMMARY

The present disclosure provides a system and method for filtering water using a pre-filter and a primary filter, both removably disposed within a housing. The pre-filter is placed in series with the primary filter. The pre-filter includes a cavity within which the primary filter may be at least in part disposed. In one embodiment, the pre-filter and the primary filter are each removably received within the housing, so that either or both of the pre-filter and primary filter may be easily removed from the housing and replacement filters provided. Thus, a simple, convenient, compact filtering apparatus is provided.

Other benefits and advantages of the present disclosure will be appreciated from the following detailed description.

### DESCRIPTION OF THE DRAWINGS

FIG. 1 is a perspective view from above of an exemplary water filter assembly in accordance with the present disclosure.

FIG. 2 is a perspective view from below of the exemplary water filter assembly shown in FIG. 1.

FIG. 3 is a bottom view of the exemplary water filter assembly shown in FIG. 1.

FIG. 4 is a top view of the exemplary water filter assembly shown in FIG. 1.

FIG. 5 is a cross-sectional view of the exemplary water filter assembly shown in FIG. 1, taken along the line 5-5 appearing in FIG. 4.

FIG. 6 is an exploded perspective view from above of the exemplary water filter assembly shown in FIG. 1.

FIG. 7 is an exploded perspective view from below of the exemplary water filter assembly shown in FIG. 1.

FIG. 8 is a cross-sectional view of an alternate embodiment of an exemplary water filter assembly including a housing and a cover.

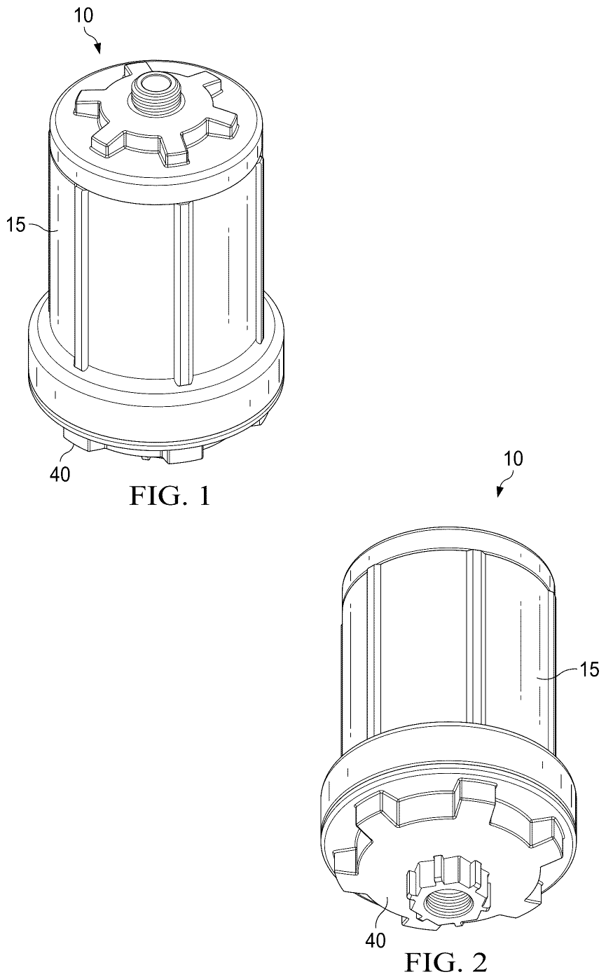

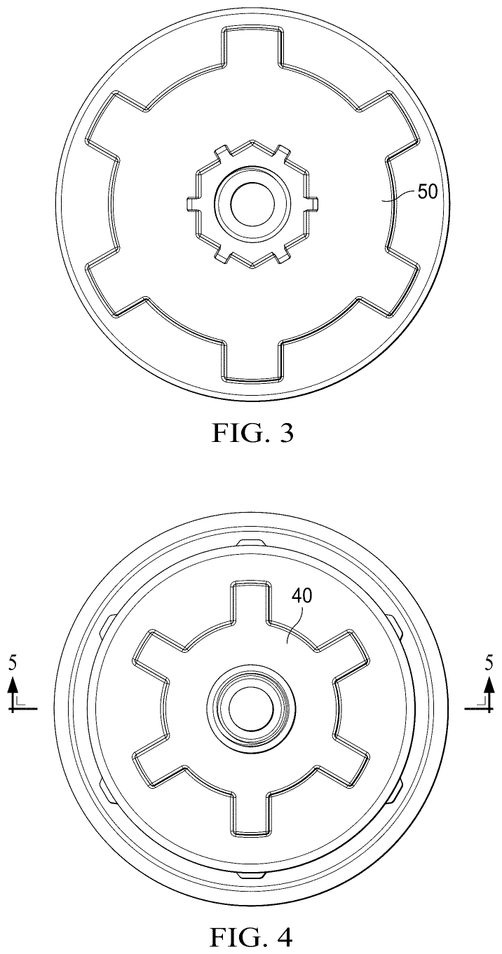

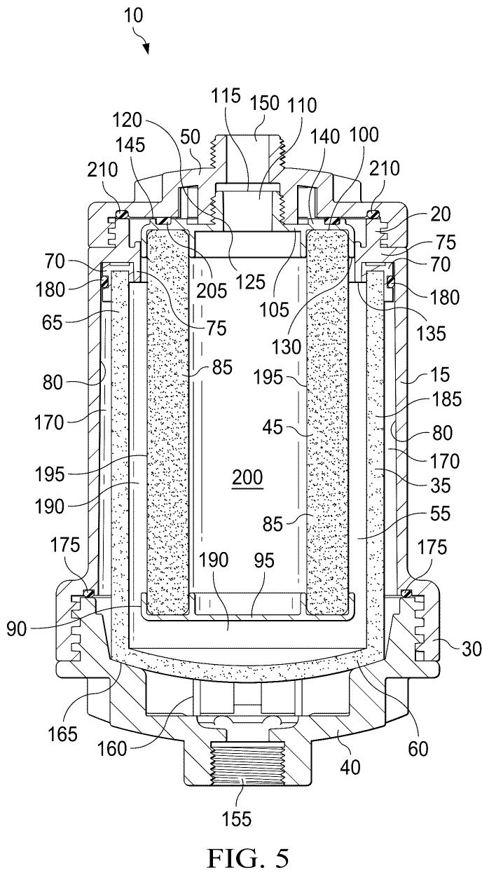

### DETAILED DESCRIPTION

Embodiments of the invention and various alternatives are described. Those skilled in the art will recognize, given the teachings herein, that numerous alternatives and equivalents exist which do not depart from the invention. It is therefore intended that the invention not be limited by the description set forth herein or below. One or more specific embodiments of the system and method will be

described below. These described embodiments are only exemplary of the present disclosure. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Further, for clarity and convenience only, and without limitation, the disclosure (including the drawings) sets forth exemplary representations of only certain aspects of events and/or circumstances related to this disclosure. Those skilled in the art will recognize, given the teachings herein, additional such aspects, events and/or circumstances related to this disclosure, e.g., additional elements of the devices described; events occurring related to water filtration; etc. Such aspects related to this disclosure do not depart from the invention, and it is therefore intended that the invention not be limited by the certain aspects set forth of the events and circumstances related to this disclosure.

The present disclosure in one embodiment provides a compact water filter assembly 10 including a housing 15 including a proximal end 20 and a distal end 30. At the housing distal end 30 a pre-filter 35 is removably received within the housing 15. The pre-filter 35 may be held in place by a housing distal end cap 40. At the housing proximal end 20 a primary filter 45 is removably received within the housing 15. The primary filter 45 may be held in place by a housing proximal end cap 50. In one embodiment the pre-filter 35 includes a cavity 55 into which at least a portion of the primary filter 45 may be placed. Such arrangement provides a compact filter assembly 10.

The pre-filter 35 in one embodiment is a cup-shaped device removably received within the distal end 30 of the housing 15. The closed end 60 of the pre-filter 35 (i.e., the bottom of the cup) is removably disposed against the housing distal end cap 40. The housing distal end cap 40 threadingly engages with the distal end 30 of the housing 15. At the proximal end 65 of the pre-filter 35 (i.e., the top or mouth of the cup) a pre-filter ring 70 may be provided. The pre-filter ring 70 may be fixedly attached about the entirety of the pre-filter 35 proximal end 65 using an adhesive. The pre-filter ring 70 is adapted to fit within a holding channel 75 disposed about the circumference of the inner wall 80 of the housing 15 proximate the housing proximal end 20.

The pre-filter 35 may be made of polyethylene. The pre-filter 35 is adapted to filter out particles sized about 5 microns and larger. The primary filter 45 includes a tubular filter material 85. The tubular filter material may include carbon. In one embodiment, the primary filter 45 is a carbon filter, and the primary filter is adapted to filter out particles sized about one micron and larger. In an alternate embodiment, the primary filter may be a water softener filter to help inhibit the effects of hard water.

At the distal end 90 of the primary filter 45, a primary filter cap 95 may be fixedly attached to the distal end of the tubular filter material 85 to close off the distal end 90 of the primary filter 45. At the proximal end 100 of the primary filter 45, a primary filter port cap 105 including a port 110 therethrough may be fixedly attached to the proximal end of the tubular filter material 85. The proximal end 115 of the primary filter port cap 105 may include threads 120 which threadingly engage with the distal side 125 of the housing proximal end cap 50.

In one embodiment, the outer side 130 of the primary filter port cap 105 abuts against the innermost wall 135 of the holding channel 75. The proximal side 140 of the primary filter port cap 105 abuts against the distal side 145 of housing proximal end cap 50 about the port 110. The port 110 is in fluid communication with an exit port 150 through the housing proximal end cap 50. An entrance port 155 is disposed through the housing distal end cap 40.

Water to be filtered enters the filter assembly 10 through the entrance port 155. The water passes through the housing distal end cap 40 and is distributed about the prefilter 35 by a plurality of supports 160 formed on the proximal side of the housing distal end cap 40. In one embodiment a shoulder 165 is provided on the proximal side of the housing distal end cap 40 about the entrance port 155. A portion of the distal end 60 of the pre-filter 35 may abut against the shoulder 165. In another embodiment, the distal end 60 of the pre-filter 35 may also abut against the proximal ends of the supports 160 formed on the proximal side of the housing distal end cap 40.

Water to be filtered travels in a space 170 between the pre-filter 35 and (i) the inner wall 80 of the housing 15 and (ii) the proximal side of the housing distal end cap 40. An o-ring 175 may be provided between the housing distal end cap 40 and the housing 15 to prevent the unwanted escape of water from the filter assembly 10. An o-ring 180 may be provided between the housing 15 and the pre-filter ring 70 to prevent the unwanted bypass of water around the pre-filter 35. The water entering the entrance port 155 thus passes through the wall 185 and distal end 60 of the pre-filter 35 to an area 190 about the primary filter 45.

The primary filter cap 95 at the distal end 90 of the primary filter 45 prevents water from bypassing the primary filter 45 at the primary filter distal end 90. Similarly, the primary filter port cap 105 prevents water from bypassing the primary filter 45 at the primary filter proximal end 100. The water instead passes through the wall 195 of the tubular filter material 85 into a primary filter inner reservoir 200. An o-ring 205 may be provided between the proximal side of the primary filter port cap 105 and the housing proximal end cap 50 to prevent the unwanted escape of water therebetween. Also, an o-ring 210 may be provided between the proximal end of the housing 15 and the housing proximal end cap 50 to prevent the unwanted escape of water therebetween. Filtered water exits the primary filter inner reservoir 200 through the port 110 of the primary filter port cap 105 and then travels out the exit port 150 disposed in the housing proximal end cap 50.

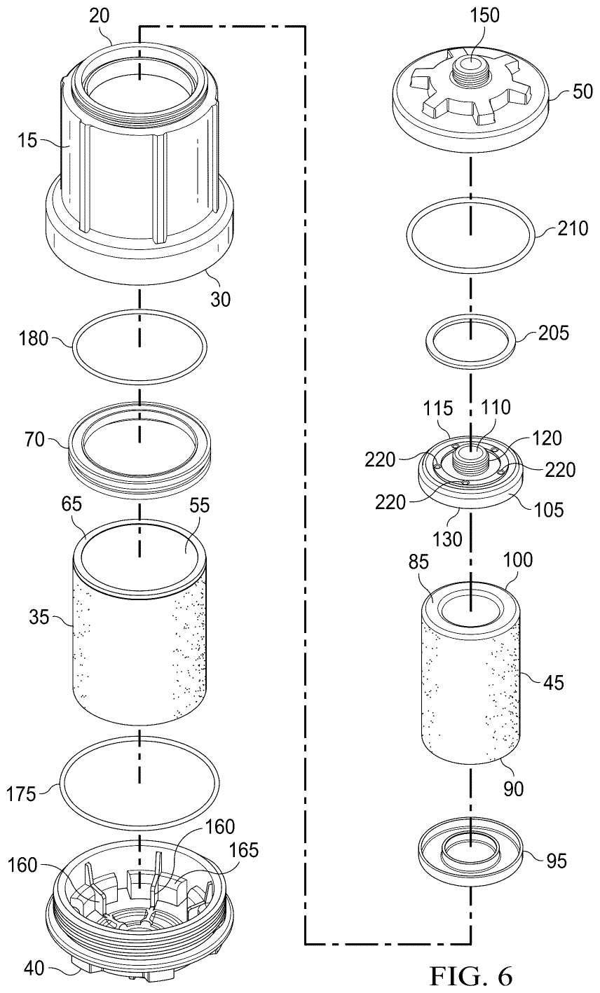

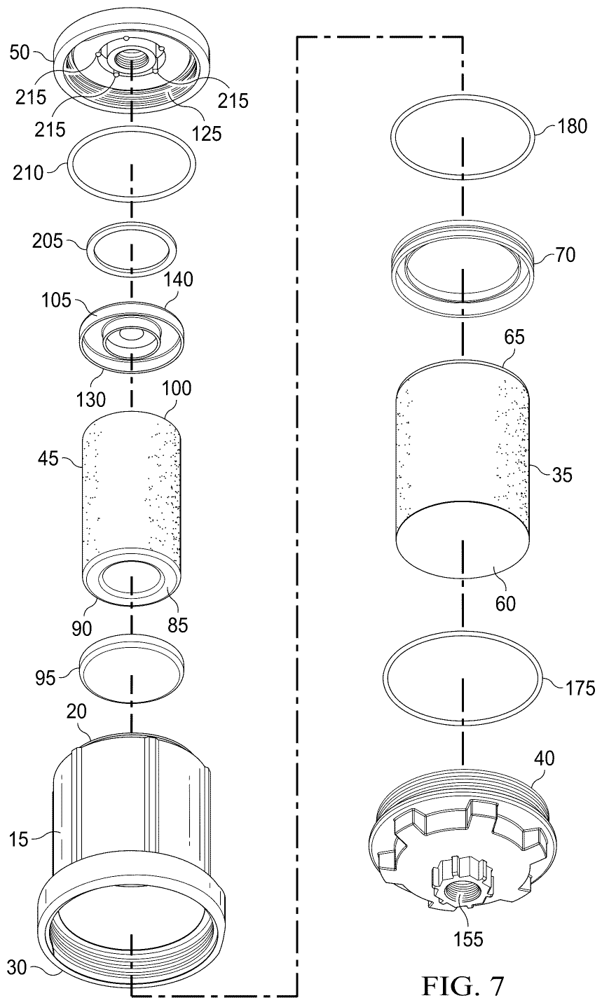

As shown in FIGS. 6 and 7, the housing proximal end cap 50 may include a plurality of protrusions 215 on its distal side. The protrusions 215 correspond to a plurality of indentations 220 on the proximal side of the primary filter port cap 105. When the primary filter port cap 105 is fully threadingly engaged with the housing proximal end cap 50, each protrusion 215 fits within an indentation 220, and an audible “click” or similar noise can be heard, and a tactile “snap” feel may be felt, as the protrusions 215 move into place in the indentations 220.

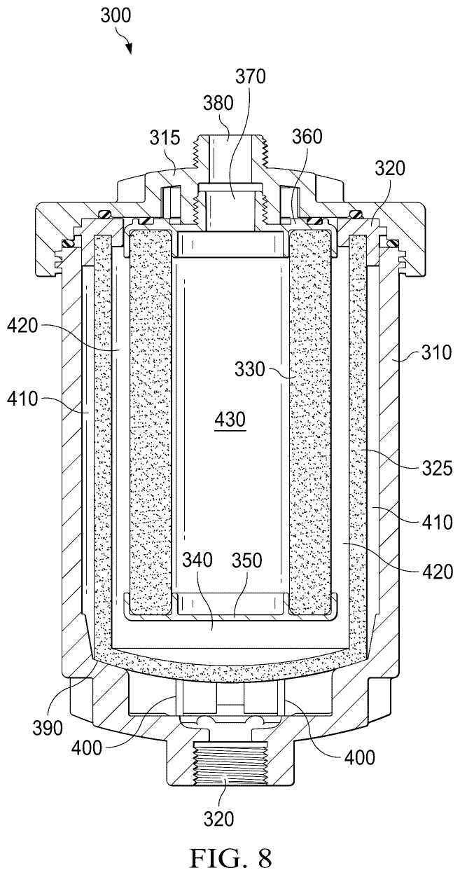

An alternate embodiment of an exemplary water filter assembly 300 is described in FIG. 8. A cup-shaped housing 310 includes a water inlet 320 therethrough in its distal end. The proximal end of housing 310 threadingly engages with a cap 315 with an exit port 380 therethrough. A cup-shaped pre-filter 325 is disposed at least in part within the housing 310. The proximal end of the pre-filter 325 includes a ring 320 affixed thereto. The pre-filter 325 including the ring 320 is bayonet fit into the distal side of the cap 315. A primary filter 330 is at least partially disposed with the space 340 at the inside of the pre-filter 325. The primary filter 330 includes an end cover 350 affixed about its distal end, and a primary filter cap 360 affixed to the proximal end of the primary filter 330. The proximal side of the primary filter cap 360 includes threads for removably threadingly engaging with the distal side of cap 315. The primary filter cap 360 includes an exit port 370 therethrough that is in fluid communication with exit port 380 in cap 315.

The pre-filter 325 may abut a shoulder 390 and/or supports 400 formed on the proximal side of the distal end of the housing 310. Water to be filtered enters inlet port 320 and is distributed into the space 410 between the housing 310 and the pre-filter 325. The water then passes through the pre-filter 325 to the space 420 between the pre-filter 325 and primary filter 330. The water then proceeds through the side walls of the primary filter 330 into inner reservoir 430. From there, the water may exit the filter assembly 300 via ports 370 and 380. O-rings may be provided to prevent the unwanted escape of water from the filter assembly 300 and to prevent the water from bypassing the pre-filter and primary filter.

In the embodiment 300, only a single cap 315 need be removed to access both the pre-filter 325 and primary filter 330. In this way, replacement filters may easily be provided to the assembly 300. Also, by removing the primary filter 330, the pre-filter 325 may be cleaned by backflushing. In one embodiment, the primary filter is a carbon filter, and the pre-filter is a polyethylene, as described herein.

It should be understood that the foregoing description is only illustrative of the invention. Various alternatives and modifications can be devised by those skilled in the art having the benefit of this disclosure, without departing from the invention. Accordingly, the invention is intended to embrace all such alternatives, modifications, and variances.

Certain exemplary embodiments of the disclosure may be described. Of course, the embodiments may be modified in form and content, and are not exhaustive, i.e., additional aspects of the disclosure, as well as additional embodiments, will be understood and may be set forth in view of the description herein. Further, while the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention.

What is claimed is:

1. A water filter assembly including:
a housing including a housing distal end and a housing proximal end;
a housing distal end cap threadingly engaged with the housing at the housing distal end, the housing distal end cap including an entrance port therethrough;
a housing proximal end cap threadingly engaged with the housing at the housing proximal end, the housing proximal end cap including an exit port therethrough;
a cup-shaped prefilter including a closed distal end, an open proximal end, and an inner pre-filter wall,
wherein the pre-filter is held in place within the housing by the distal end of the prefilter abutting the proximal side of the housing distal end cap and by the proximal end of the prefilter being disposed within a channel formed on the inside wall of the housing and proximate the housing proximal end;
a tubular primary filter including a distal end closed by a primary filter end cap and a proximal end including a primary filter port cap with a port therethrough,
wherein at least a portion of the primary filter is disposed in a space at least in part defined by the pre-filter inner wall; and
wherein the primary filter port cap is threadingly engaged with the distal side of the housing proximal end cap;
to create a continuous fluid pathway:
from the entrance port to a first space about the pre-filter and defined in part by an inner wall of the housing
from the first space about the pre-filter through the pre-filter wall to a second space about the primary filter and defined in part by the pre-filter inner wall,
from the second space about the primary filter through the primary filter wall to a third space defined at least in part by the primary filter inner wall, and
from the third space through the port through the primary filter port cap and through the exit port.

2. The water filter assembly of claim 1 including a plurality of protrusions formed on the distal side of the housing proximal end cap and a plurality of indentations formed on the proximal side of the primary filter port cap, wherein threadingly engaging the primary filter port cap with the distal side of the housing proximal end cap aligns each protrusion with a corresponding indentation, so that when the protrusions become disposed within the indentations an audible sound is created.
